(19) United States
(12) Patent Application Publication
(10) Pub. No.: US 2010/0041540 A1
(43) Pub. Date: Feb. 18, 2010

(54) GLASS COMPOSITION FOR A LAMP, GLASS PART FOR A LAMP, LAMP, AND ILLUMINATION DEVICE

(76) Inventors: Junko Toda, Osaka (JP); Yasurou Niguma, Osaka (JP); Masanobu Itou, Hyogo (JP)

Correspondence Address: SNELL & WILMER L.L.P. (Panasonic), 600 ANTON BOULEVARD, SUITE 1400, COSTA MESA, CA, 92626, US

(21) Appl. No.: 12/523,528

(22) PCT Filed: Oct. 24, 2008
(86) PCT No.: PCT/JP2008/003018

§ 371 Date: Jul. 16, 2009

(30) Foreign Application Priority Data
Nov. 13, 2007 (JP) 2007-294833
Jul. 7, 2008 (JP) 2008-176544

(51) Int. Cl. C03C 3/087

(52) U.S. Cl. 501/70

(57) ABSTRACT

<br></br> A glass composition contains the following constituents expressed in terms of oxides: 65 wt % to 75 wt % of SiO₂; 1 wt % to 5 wt % of Al₂O₃; 0.5 wt % to 5 wt % of Li₂O; 5 wt % to 12 wt % of Na₂O; 3 wt % to 7 wt % of K₂O; 12 wt % to 18 wt % of Li₂O+Na₂O+K₂O; 2.1 wt % to 7 wt % of MgO; 2 wt % to 7 wt % of CaO; 0 wt % to 0.9 wt % of SrO; 7.1 wt % to 12 wt % of BaO; and substantially no PbO. The glass composition for a lamp is substantially lead-free, has an electrical insulation suitable for an illumination purpose, and further reduces the risk of devitrification.

### TECHNICAL FIELD

The present invention relates to a glass composition for a lamp, a glass part for a lamp, a lamp, and an illumination device.

### BACKGROUND ART

Generally, glass parts for a lamp, such as glass bulbs and flared stems, are made of glass with high electrical insulation in order to prevent electric current from flowing through the glass parts. Passage of electric current through glass parts may cause a short in circuitry of the illumination device or generation of abnormal heat to melt the glass parts.

One type of commonly-used glass having high electrical insulation is so-called lead glass, which contains a large amount of PbO (lead oxide). However, because lead is a hazardous substance, the use of lead glass has been officially regulated in recent years. In an attempt to seek for an alternative glass having electrical insulation comparable to that of lead glass, various types of glass containing a large amount of SrO (strontium oxide), which is a constituent serving to improve the electrical insulation, have been suggested (see Patent Citation 1 listed below). However, it has been found that addition of a large amount of SrO may cause crystallization and thus cause devitrification of the glass. In view of this, glass has been suggested that has an SrO content limited to 2.5 wt % or less to suppress devitrification (see Patent Citation 2 listed below).

### Patent Citation 1: JP Patent Application Publication No. 06-206737

### Patent Citation 2: JP Patent Application Publication No. 2005-213129

### DISCLOSURE OF INVENTION

### Problems Solved by the Invention

Unfortunately, however, the present inventors have found the following based on experiments conducted on the glass prepared according to Patent Citation 2. That is, the glass according to Patent Citation 2 fails to satisfy the required properties to be suitable for illumination purposes. Especially, the devitrification tendency of the glass needs to be further improved.

In view of the above problems, a primary object of the present invention is to provide a glass composition for use in a lamp, which composition is substantially lead-free, achieves electrical insulation suitable for illumination purposes, and involves less risk of devitrification. Another object of the present invention is to provide a glass part for a lamp, a lamp, and an illumination device that are all manufactured from such a glass composition.

### Means to Solve the Problem

In order to achieve the above objects, the present invention provides a glass composition for a lamp, which composition comprises the following constituents expressed in terms of oxides: 65 wt % to 75 wt % of SiO₂; 1 wt % to 5 wt % of Al₂O₃; 0.5 wt % to 5 wt % of Li₂O; 5 wt % to 12 wt % of Na₂O; 3 wt % to 7 wt % of K₂O; 12 wt % to 18 wt % of Li₂O+Na₂O+K₂O; 2.1 wt % to 7 wt % of MgO; 2 wt % to 7 wt % of CaO; 0 wt % to 0.9 wt % of SrO; 7.1 wt % to 12 wt % of BaO; and substantially no PbO. Note that “to contain substantially no PbO” means that PbO is not contained at all as well as that PbO is contained to the extent of impurity.

In another aspect, the present invention provides a glass composition for a lamp, which composition comprises the following constituents expressed in terms of oxides: 65 wt % to 75 wt % of SiO₂; 1 wt % to 3 wt % of Al₂O₃; 1 wt % to 3 wt % of Li₂O; 7 wt % to 10 wt % of Na₂O; 3 wt % to 6 wt % of K₂O; 13 wt % to 17 wt % of Li₂O+Na₂O+K₂O; 3 wt % to 6 wt % of MgO; 3 wt % to 6 wt % of CaO; 0 wt % to 0.9 wt % of SrO; 7.1 wt % to 10 wt % of BaO; and substantially no PbO.

Note that each numerical range defined in the present application includes the upper and lower limits of that range. For example, the range of 65 wt % to 75 wt % means that both 65 wt % and 75 wt % are included in the range.

SiO₂ is the main constituent that forms glass networks and the SiO₂ content in the glass composition falls within the range of 65 wt % to 75 wt %. With the SiO₂ content lower than 65 wt %, the water resistance of the glass decreases. Yet, with the SiO₂ content higher than 75 wt %, the viscosity of the glass at high temperatures increases, which leads to significantly decrease the workability of the glass.

Al₂O₃ is a constituent that suppresses alkaline elution and forms glass networks. That is to say, addition of Al₂O₃ leads to reduce the workability of the glass. The Al₂O₃ content in the glass composition falls within the range of 1 wt % to 5 wt %. With the Al₂ O₃ content lower than 1 wt %, the effect of suppressing alkaline elution is not sufficiently produced. Yet, with the Al₂O₃ content higher than 5 wt %, striae may occur in the glass or the viscosity of the glass at high temperatures increases, which leads to decrease the workability of the glass. It is therefore preferable to be suitable for a glass bulb that the Al₂O₃ content falls within the range of 1 wt % to 3 wt %.

Li₂O, Na₂O and K₂O are alkaline metal oxides and these constituents disconnect the bonds of SiO₂ present in the glass to lower the viscosity of the glass. In addition, Li₂O, Na₂O and K₂O largely affect the expansion coefficient. Although alkaline elution (i.e., the amount of alkaline eluted) increases with the amount of the individual constituents mentioned above, the coexistence of Li₂O, Na₂O and K₂O produces a phenomenon called a mixed alkali effect to reduce alkaline elution.

Na₂O is a constituent that is cheaper and more effective to lower the viscosity of the glass as compared with other raw materials. For this reason, Na₂O is useful to improve the workability of the glass. The Na₂O content in the glass composition falls within the range of 5 wt % to 12 wt %. With the Na₂O content lower than 5 wt %, the viscosity of the glass increases to reduce the workability. Yet, the Na₂O content higher than 12 wt % reduces the water resistance of the glass, which leads to increase alkaline elution. It is therefore preferable to be suitable for a glass bulb that the Na₂O content falls within the range of 7 wt % to 10 wt %.

The K₂O content in the glass composition falls within the range of 3 wt % to 7 wt %. With the K₂O content lower than 3 wt %, the mixed alkali effect described above is not produced and thus the alkaline elution increases. Yet, with the K₂O content higher than 7 wt %, the water resistance of the glass decreases and thus alkaline elution increases. It is therefore preferable to be suitable for a glass bulb that the K₂O content falls within the range of 3 wt % to 6 wt %.

The Li₂O content in the glass composition falls within the range of 0.5 wt % to 5 wt %. With the Li₂O content lower than 0.5 wt %, the mixed alkali effect described above is not produced and thus alkaline elution increases. Yet, with the Li₂O content higher than 5 wt %, the water resistance of the glass decreases and thus the alkaline elution increases. In addition, since Li₂O is a relatively expensive raw material, the manufacturing cost increases with the Li₂O content. It is therefore preferable to be suitable for a glass bulb that the Li₂O content falls within the range of 1 wt % to 3 wt %.

The total content of Li₂O, Na₂O and K₂O falls within the range of 12 wt % to 18 wt %. With the total content of Li₂O, Na₂O and K₂O falling within this range, good workability of the glass is ensured. With the total content lower than 12 wt %, the viscosity of the glass increases to reduce the workability. Yet, with the total content higher than 18 wt %, the water resistance of the glass decreases and thus alkaline elution increases. It is therefore preferable to be suitable for a glass bulb that the total content of Li₂O, Na₂O and K₂O falls within the range of 13 wt % to 17 wt %.

MgO, CaO, SrO and BaO are alkaline earth metal oxides and have an influence on the electrical insulation of the glass. The first factor responsible for the influence is that an alkaline earth metal having a larger atomic radius tends to be a physical obstruction that blocks migration of alkaline metals. As a consequence, the presence of such an alkaline earth metal serves to suppress the electric conductivity. From this standpoint, it is noted that Ba having the largest atomic radius among all the alkaline earth metals suppresses the electric conductivity most. The second factor is that an alkaline earth metal with a larger atomic radius tends to disconnect or modify the skeleton of surrounding SiO₂ to provide space allowing alkaline metals to more easily pass through. As a consequence, the presence of such an alkaline earth metal serves to increase the electric conductivity. From this standpoint, it is noted that Ba having the largest atomic radius among all the alkaline earth metals increases the electric conductivity most.

MgO and CaO are constituents that affect the electrical insulation of the glass, disconnect the bonds of SiO₂ present in the glass to lower the viscosity, and increase the water resistance of the glass. It is noted, in addition, that MgO and CaO also affect the glass properties such as chemical durability and devitrification. The MgO content in the glass composition falls within the range of 2.1 wt % to 7 wt %, and the CaO content of the glass composition falls within the range of 2 wt % to 7 wt %. With the MgO content lower than 2.1 wt % or the CaO content lower than 2 wt %, the chemical durability of the glass decreases. Yet, with either the MgO or CaO content higher than 7 wt %, the viscosity of the glass tends to vary with temperature too greatly. This means that at the time of processing, the glass cools off too rapidly, which leads to reduce the workability of the glass and thus lower the lamp manufacturing yield. It is therefore preferable to be suitable for a glass bulb that the MgO content and the CaO content both fall within the range of 3 wt % to 6 wt %.

The SrO content of the glass composition falls within the range of 0 wt % to 0.9 wt %. With the SrO content higher than 0.9 wt %, the tendency of the glass toward devitrification at the molten state increases, which is undesirable as glass for a lamp. In order to reduce the devitrification tendency, it is desirable to avoid adding SrO as much as possible.

The BaO content in the glass composition falls within the range of 7.1 wt % to 12 wt %. Similarly to MgO, CaO and SrO as described above, BaO affects the electrical insulation of the glass. In relation to the MgO, CaO and SrO contents that are each limited to a certain amount or less in view of the chemical durability and the devitrification tendency of the glass, the BaO content less than 7.1 wt % makes it difficult to ensure a sufficient level of electrical insulation of the glass. Yet, with the BaO content higher than 12 wt %, the tendency toward devitrification of the glass at the molten state increases, which is undesirable as glass for a lamp. It is therefore preferable to be suitable for a glass bulb that the BaO content falls within the range of 7.1 wt % to 10 wt %.

Note that Li₂O, Na₂O and K₂O have the tendency to increase the electric conductivity of the glass. In contrast, MgO, CaO, SrO and BaO are effective to ensure the electrical insulation of the glass. By optimizing the contents of the respective constituents, the desired level of electrical insulation is achieved.

Note that one or more ultraviolet absorbents such as CeO₂, TiO₂, SnO and SnO₂ may be added to the glass in order to impart ultraviolet absorbing function. As long as the content of each ultraviolet absorbent is limited to 1 wt % or less, the desirable properties of the glass composition according to the present invention would not be impaired. In addition, one or more fining agents such as Sb₂O₃, SO₃, C, F and Cl may be added. As long as the content of each fining agent is limited to 1 wt % or less, the desirable properties of the glass composition according to the present invention would not be impaired. In addition, up to 0.5 wt % of impurities typified by, for example, Fe₂O₃ may be present without the risk of impairing the desirable properties of the glass composition according to the present invention.

According to yet another aspect of the present invention, the glass composition may satisfy the following relationship by weight.

0.76≦(MgO+CaO)/(SrO+BaO)≦1.19 [Math.1]

As described above, alkaline earth metal oxides disconnect the bonds of SiO₂ present in the glass to widen gaps in the glass networks. As a result, wide pathways are provided for high-mobility alkaline metals, especially sodium, to migrate. Here, it should be noted that among alkaline earth metals, magnesium is substantially equal to sodium in atomic radius and that calcium is larger than sodium in atomic radius but is relatively small among the alkaline earth metals. Therefore, in the case where magnesium or calcium is added to the glass composition, the gaps in the network structure are narrower than that of the glass composition containing barium or strontium, which has a larger atomic radius. In view of this, it is said that the effect of suppressing alkaline elution is expected to increase with the ratio of MgO or CaO by weight.

At the same time, it can be said that an alkaline earth metal having a larger atomic radius tends to physically obstruct the passage of alkaline metals, which serves to suppress the electric conductivity. That is, SrO and BaO having a larger atomic radius suppresses the electric conductivity more effectively. The effect of suppressing alkaline elution increases with the ratio of SrO and BaO by weight.

The balance between the above two factors determines the desirable range of the alkaline earth metal content to suppress alkaline elution. The present inventors have found that the range satisfying the following relationship is effective to sufficiently suppress alkaline elution.

0.76≦(MgO+CaO)/(SrO+BaO)≦1.19 [Math.2]

According to yet another aspect of the present invention, the total content of Li₂O+Na₂O+K₂O may be less than 15.8 wt %, the total content of MgO, CaO, SrO, and BaO may be less than 15.6 wt %, and a content ratio by weight defined by the following relationship may be satisfied.

0.76 [symbol] (MgO+CaO)/(SrO+BaO) [Math.3]

With a high total content of alkaline metal oxides (i.e., Li₂O, Na₂O and K₂O), the working point of the resulting glass tends to be lower. Examples 4 and 5 of the present invention described below each contain 15.8 wt % or more of alkaline metal oxides in total and exhibit the working point below 1000 degrees C.

It is also noted that even with the total content of alkaline metal oxides being less than 15.8 wt %, the working point of the resulting glass can be relatively low as long as the total content of alkaline earth metal oxides is high. In Examples 7-10 of the present invention described blow, the total content of alkaline metal oxides is less than 15.8 wt % but the total content of alkaline earth metal oxides is equal to 15.6 wt % or higher. The working point of Examples 7-10 is below 1000 degrees C.

In addition, the following should be noted regarding the contents of alkaline earth metal oxides. With an increase of the content of SrO and BaO, each of which has a larger atomic radius than the other alkaline earth metal oxides, the working point of the resulting glass tends to be relatively lower. Examples 6 and 11 of the present invention described below both satisfy the following relationship and exhibit the working point below 1000 degrees C.

0.76≧(MgO+CaO)/(SrO+BaO) [Math.4]

Examples 1-3 of the present invention described below all exhibit the working point falling within the range of 1000 degrees C. to 1050 degrees C. In each of Examples 1-3, the total content of Li₂O, Na₂O and K₂O is less than 15.8 wt %, and the total content of MgO, CaO, SrO and BaO is less than 15.6 wt %. In addition, the following relationship is satisfied.

0.76 [symbol] (MgO+CaO)/(SrO+BaO) [Math.5]

According to yet another aspect of the present invention, a softening point of the glass may fall within the range of 650 degrees C. to 720 degrees C.

According to yet another aspect of the present invention, a thermal expansion coefficient of the glass at a temperature from 30 degrees C. to 380 degrees C. may fall within the range of 90*10⁻⁷K⁻¹ to 100*10⁻⁷K⁻¹.

According to yet another aspect, the present invention provides a glass part for a lamp and the glass part is manufactured from the glass composition defined above.

According to yet another aspect, the present invention provides a lamp comprising the glass part defined above.

According to yet another aspect, the present invention provides an illumination device comprising the lamp defined above.

### EFFECTS OF THE INVENTION

According to the present invention, the glass composition contains a limited amount of SrO. By virtue of the limited SrO content, devitrification of the glass hardly occurs. In addition, the contents of MgO, CaO and BaO are limited to fall within the predetermined ranges, so that the resulting glass is ensured to achieve a suitable level of electrical insulation for illumination purposes.

According to the present invention, the glass part for a lamp is manufactured from the glass composition described above. By virtue of the glass composition, devitrification of the glass hardly occurs and thus the manufacturing yield improves. In addition, because the suitable electrical insulation is ensured, the glass part is suitable for use in a lamp.

According to the present invention, the lamp comprises the glass part described above. Thus, the manufacturing yield of the lamp is improved and thus the manufacturing cost of the lamp is reduced. In addition, the lamp exhibits a good luminous flux maintenance factor.

According to the present invention, the illumination device comprises the lamp described above and thus its manufacturing cost is lower than that of a conventional illumination device. In addition, the illumination device of the present invention exhibits a luminous flux maintenance factor comparable to that of a conventional lamp.

### BRIEF DESCRIPTION OF THE DRAWINGS

FIG. 1 is a table showing the constituents of glass compositions according to the present invention, along with their properties.

FIG. 2 is a view illustrating an alkaline elution measuring method employed in the present invention.

FIG. 3 is a graph showing the correlation between the alkaline elution amount measured by a JIS-compliant method and the electrical conductivity measured by the alkali measuring method employed in the present invention.

FIG. 4 is a table showing the constituents of glass compositions according to Comparative Examples along with their properties.

FIG. 5 is a partly-broken plan view of a circular fluorescent lamp according to Embodiment 1 of the present invention.

FIG. 6 is a view illustrating a stem before being attached to a glass bulb, and (a) shows members forming the stem and (b) shows a sectional view of the stem.

FIG. 7 is a table showing the luminous flux maintenance factors of circular fluorescent lamps.

FIG. 8 is a partly-broken plan view schematically showing a cold cathode fluorescent lamp according to Embodiment 2 of the present invention.

FIG. 9 is a table showing the luminous flux maintenance factors of cold cathode fluorescent lamps.

FIG. 10 is an oblique view schematically showing an illumination device according to a modification of the present invention.

### DESCRIPTION OF THE CHARACTERS

20, 32, 33, 61, 62 Glass Part
10, 60 Lamp
80 Illumination Device

### BEST MODE FOR CARRYING OUT THE INVENTION

Best modes for carrying out the invention are described below with reference to the accompanying drawings.

I. Glass Composition

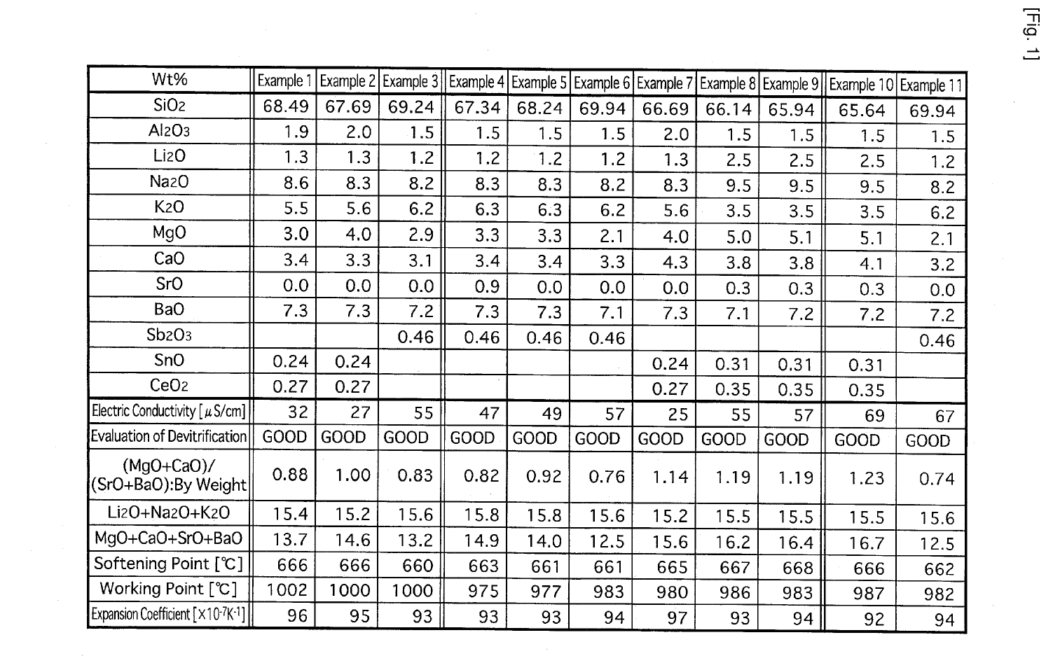

First of all, the following describes a glass composition according to the present invention with reference to Examples 1-11 of the present invention. FIG. 1 is a table showing the constituents of the glass compositions of Examples 11, along with their properties.

i. Properties of Glass Compositions

The properties of each glass composition (alkaline elution amount, expansion coefficient, softening point, working point, and devitrification tendency) are evaluated in the following manner.

Alkaline Elution Amount

One method commonly employed to measure the amount of alkaline component eluted from glass is a test method of glass apparatus for chemical analysis compliant with JIS (JIS R 3502). Briefly speaking, the following processes are carried out according to the JIS R 3502 method. First, a glass sample is crashed into particles (having diameter falling within the range of 250 micrometers to 420 micrometers) with the use of an mortar, for example. The glass particles are then washed with ethyl alcohol to remove unwanted fine particles. Next, the washed glass particles are heated in a boiling water bath for 60 minutes to cause alkaline to elute from the glass particles. The concentration of alkaline component in the eluate is determined by neutralization titration with sulfuric acid. The thus determined value is converted into the amount of alkaline components eluted from the glass particles.

The test method compliant with JIS has the following disadvantages. That is, if the washing with ethyl alcohol is not sufficiently done, unwanted fine powder remains in glass particles. The presence of fine powder leads to a significant increase of the total surface area of the glass particles in distilled water. In such a case, it is impossible to accurately measure the amount of alkaline elution. In addition, the JIS test method requires complicated processes, including grinding the glass sample into small particles, washing the particles to remove unwanted fine powder, and neutralization titration. Because of these disadvantages, there has been a desire for a method for measuring the alkaline elution amount more easily and accurately.

In view of the above, the present inventors have established a new method that enables the alkaline elution amount to be measured more easily and accurately than by the JIS-compliant method. According to the new measurement method, a block of glass sample is immersed in distilled water to cause alkaline to be eluted into the distilled water. The electric conductivity of the alkaline eluate is measured and the amount of alkaline elution is derived from the thus measured electric conductivity.

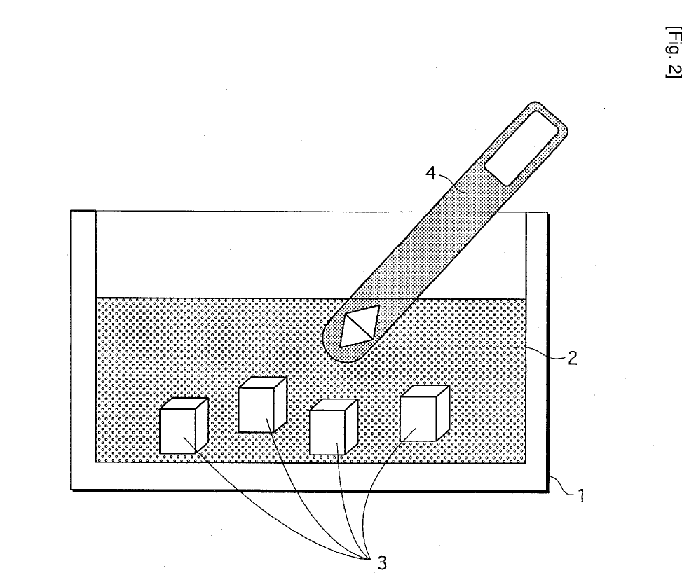

FIG. 2 is a view illustrating the new alkaline elution measuring method employed in the present invention. The specific procedure of the measurement method is described with reference to FIG. 2.

First of all, blocks cut out from a glass sample are allowed to stand for 45 to 50 hours in a bath constantly maintained to fall within the temperature range of 75 degrees C. to 85 degrees C. and the humidity range of 85% to 95% in order to moisturize the blocks. For a higher measurement accuracy, it is preferable to adjust the bath temperature, bath humidity, and immersion time respectively to 80 degrees C., 90%, and 48 hours, which are values close to the median values of the respective ranges.

Next, as illustrated in FIG. 2, a water tank 1 is loaded with 100 ml of distilled water 2 of 70 degrees C. to 80 degrees C. Glass samples 3 having been moisturized are immersed in the distilled water for one hour. Since the distilled water 2 is kept at relatively low temperatures of 70 degrees C. to 80 degrees C., the measurement is made on alkaline that is caused to elute in a manner closer to an actual case as compared with alkaline elution forced to occur in boiling distilled water according to the JIS test method.

Preferably, the glass samples 3 to be immersed are so adjusted that the total surface area of all the glass samples 3 falls within the range of 4500 mm² to 5500 mm². More preferably, the total surface area should be about 5000 mm². For example, eight glass samples 3 each of which is cut into a cubic shape of about 15 mm*15 mm*2.5 mm are immersed.

Then, the glass samples 3 are taken out of the distilled water 2 to obtain alkaline eluate. The alkaline eluate is then stabilized at 25 degrees C., and the electric conductivity of the alkaline eluate is measured with a commercially available compact conductivity meter 4 (trade name: Twin Cond B-173) having an immersion-proof sensor.

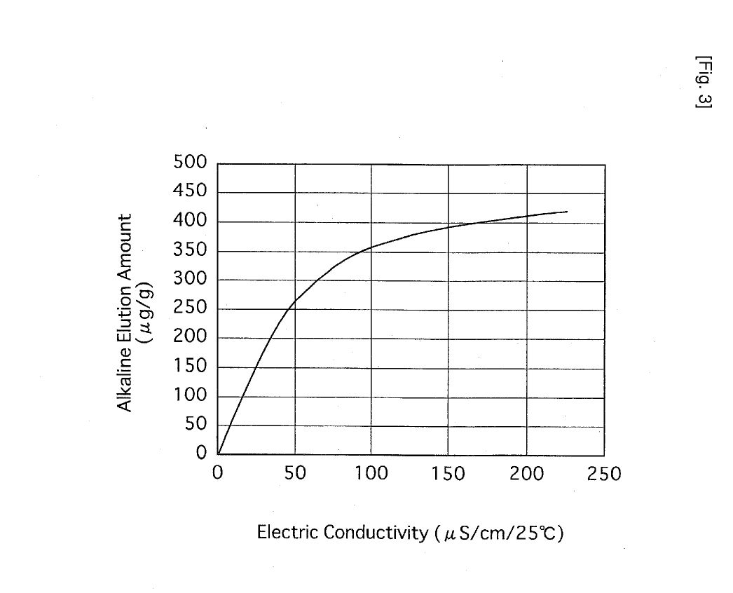

FIG. 3 is a graph showing the correlation between the alkaline elution amount measured by the JIS-compliant method and the electrical conductivity measured by the new alkaline elution measuring method employed in the present invention. There is a correlation as shown in FIG. 3. In general, glass suitable for a glass bulb of a fluorescent lamp has a property which results in the alkaline elution amount of 270 micrograms per gram or less. As is shown in FIG. 3, glass with the alkaline elution amount of 270 micrograms per gram has the electric conductivity of 57 micro-Siemens per centimeter. In view of this, it is said that glass having the electric conductivity of 57 micro-Siemens per centimeter or less is suitable for a glass bulb.

In other words, the electric conductivity of glass indicates, although indirectly, the alkaline elution amount of the glass. In order to be suitable for use in a lamp, the glass needs to have the electric conductivity of 57 micro-Siemens per centimeter or less at 25 degrees C. If the electric conductivity is higher than 57 micro-Siemens per centimeter, various problems resulting from generation of amalgam are more notably brought about.

Since the measurement method employed in the present invention uses blocks of the glass sample, the total surface area of the glass blocks to be immersed into distilled water can be easily adjusted. Consequently, the alkaline elution amount is measured more accurately than by the JIS compliant test method. In addition, since the measurement method employed in the present invention determines the alkaline elution amount of the glass based on the electric conductivity, the measurement accuracy is ensured even if a large amount of alkaline is eluted.

In addition, since the measurement method according to the present invention uses blocks of the glass sample, there is no need to go through the process of grinding the glass sample into small particles and the process of washing the glass particles. In addition, the electric conductivity of alkaline eluate is measured simply by immersing the electrodes of the conductivity meter 4 directly into the alkaline eluate. That is to say, the measurement is made more easily than with the JIS-compliant method since the complicated process of neutralization titration is not required.

Expansion Coefficient, Softening Point, and Working Point

The expansion coefficient, softening point, and working point of glass were measured using samples prepared in the following manner. First of all, chemical agents as glass raw materials were mixed according to a predetermined composition. Next, 100 g of the resulting mixture was put into a platinum crucible, followed by heating in an electric furnace at 1500 degrees C. for three hours to melt the mixture of glass raw materials. The molten glass was then poured into a metal mold to produce a desired shape. The shaped glass was slowly cooled (annealed) for 12 hours to relieve internal stresses. The resulting glass mass was cut into a predetermined shape with, for example, a cutting machine to obtain glass samples.

The expansion coefficients of Examples 1-11 were measured using a thermomechanical analyzer (TAS300 TMA8140C manufactured by Rigaku Cooperation). For the measurements, glass samples each having the shape of a cylindrical column measuring 5 mm in diameter and 10 mm in height were prepared. The measurements were made at the temperatures ranging from 30 degrees C. to 380 degrees C. under compressive load to obtain the mean coefficient of linear thermal expansion of the glass samples.

In order to hermetically seal a lead wire to an end of a glass bulb, it is preferable that the thermal expansion coefficient of the glass bulb is approximately the same as the thermal expansion coefficient of the lead wire. The dumet wire used for a sealing portion of the lead wire (external lead wire) has the thermal expansion coefficient of 94*10⁻⁷K⁻¹. Thus, it is preferable that the thermal expansion coefficient of the glass falls within the range of 90*10⁻⁷K⁻¹ to 100*10⁻⁷K⁻¹.

The softening point of glass is a temperature at which the viscosity of the glass reaches 10^{7.65} decipascal-seconds at which the glass attains flowability. As glass suitable for a glass bulb, it is preferable that the softening point falls within the range of 650 degrees C. to 720 degrees C. With the softening point lower than 650 degrees C., it is inevitable that the glass bulb deforms because of heat applied during a phosphor baking process conducted to vaporize the binder present in the phosphor suspension. Yet, with the softening point higher than 720 degrees C., the glass needs to be heated to a higher temperature to duly carry out the sealing process, which requires a facility with a high combustion capability.

The working point of glass refers to a specific temperature at which the viscosity of the glass reaches 10⁴ decipascal-seconds. The glass needs to be processed at temperatures lower than the working point. Therefore, to be suitable for a glass bulb, the glass preferably has the working point that falls within the range of 1000 degrees C. to 1050 degrees C. With the working point lower than 1000 degrees C., the working point range (i.e., the range from the softening point to the working point) becomes too narrow, which leads to a reduction in workability. Yet, with the working point higher than 1050 degrees C., the temperature at which the glass starts to melt becomes too high, which leads to a reduction in workability and an increase in cost of the melting process.

Devitrification

Each glass sample having been fused was visually inspected to evaluate as to whether devitrification had occurred (evaluated as “POOR”) or not occurred (evaluated as “GOOD”).

ii. Significance of Upper and Lower Limits of Ranges

The glass composition according to the present invention is not limited to Examples 1-11 shown in FIG. 1. Yet, in order to have the favorable properties for use in a lamp, the glass composition preferably contains the following constituents in the following contents in terms of oxides: 65 wt % to 75 wt % of SiO₂; 1 wt % to 5 wt % of Al₂O₃; 0.5 wt % to 5 wt % of Li₂O; 5 wt % to 12 wt % of Na₂O; 3 wt % to 7 wt % of K₂O; 12 wt % to 18 wt % of Li₂O+Na₂O+K₂O; 2.1 wt % to 7 wt % of MgO; 2 wt % to 7 wt % of CaO; 0 wt % to 0.9 wt % of SrO; 7.1 wt % to 12 wt % of BaO; and substantially no PbO. Further, it is preferable that the following relationship is satisfied in terms of the ratio by weight.

0.76≦(MgO+CaO)/(SrO+BaO)≦1.19 [Math.6]

Still further, it is preferable that the total content of Li₂O, Na₂O and K₂O be less than 15.8 wt % in terms of oxides, that the total content of MgO, CaO, SrO and BaO be less than 15.6 wt %, and that the following relationship is satisfied in terms of the ratio by weight.

0.76 [symbol] (MgO+CaO)/(SrO+BaO) [Math.7]

The reasons as to why the above conditions are preferable are described below through comparison with Comparative Examples.

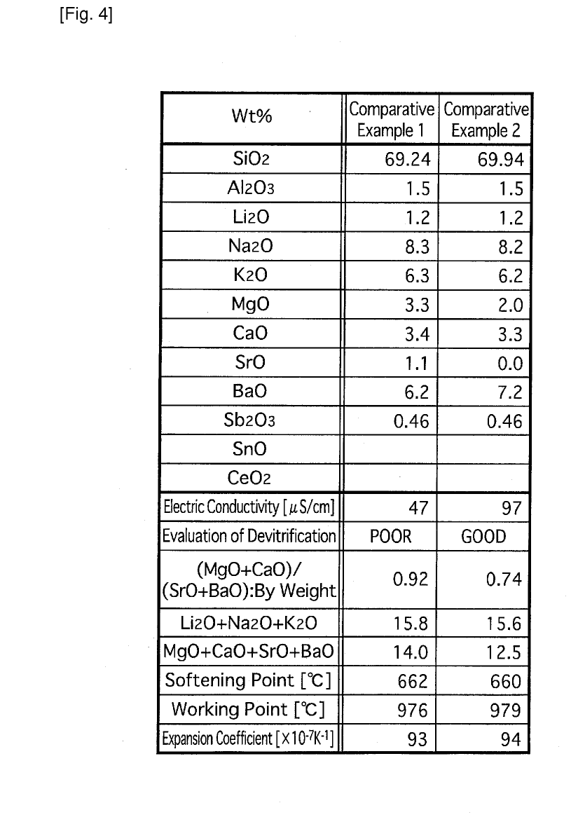

FIG. 4 is a table showing the constituents of glass compositions according to Comparative Examples, along with their properties. Note that the properties of the glass compositions according to Comparative Examples were measured by the same method as that used to measure the glass compositions according to Examples of the present invention.

Comparison is made between Examples 1-11 and Comparative Example 1 to identify the SrO content effective to suppress devitrification. Examples 1-11 with the SrO content equal to or below 0.9 wt % all exhibited the devitrification tendency evaluated as “GOOD”. On the other hand, Comparative Example 1 with the SrO content exceeding 0.9 wt % (1.1 wt %) exhibited the devitrification tendency evaluated as “POOR”. Based on the evaluation, it is known that the SrO content needs to be limited to 0.9 wt % or less in order to prevent occurrence of devitrification.

Comparison is made between Examples 1-11 and Comparative Example 2 to identify necessary constituents to obtain an electrical insulation suitable for illumination purposes. Comparative Example 2 falls out of the composition range of the present invention and exhibited the electric conductivity as high as 97 micro-Siemens per centimeter, which means that the amount of alkaline elution was relatively large. That is to say, the glass of Comparative Example 2 has a low electrical insulation and thus alkaline metal ions would migrate in the glass relatively easily. In view of this, it is said that the glass having an electrical insulation suitable for illumination purposes cannot be obtained without satisfying the composition range according to the present invention.

Comparison is made between Examples 1-9 and Examples 10 and 11 to see the influence on alkaline elution exerted by the ratio of alkaline earth metal oxides by weight. Examples 1-9 each satisfying the following relationship exhibited the electric conductivity equal to 57 micro-Siemens per centimeter or less, which indicated that the amount of alkaline elution was relatively small.

0.76≦(MgO+CaO)/(SrO+BaO)≦1.19 [Math.8]

On the other hand, Example 10 contains alkaline earth metal oxides exceeding the ratio of 1.19 by weight, whereas Example 11 contains alkaline earth metal oxides less than the ratio of 0.76. Examples 10 and 11 both exhibited the alkaline elution amount exceeding 57 micro-Siemens per centimeter. In view of this, it is known that the ratio of alkaline earth metal oxides by weight needs to fall within the range of 0.76 to 1.19 to obtain glass with low alkaline elution.

Examples 1-3 are compared to Examples 4-11 to see the influence on the working point exerted by the MgO content, the CaO content, and the Li₂O, Na₂O and K₂O content. Examples 1-3 each satisfy that the total content of Li₂O, Na₂O and K₂O in terms of oxides is less than 15.8 wt %, that the total content of MgO, CaO, SrO and BaO is less than 15.6 wt %, and that and the following relationship is satisfied.

0.76 [symbol] (MgO+CaO)/(SrO+BaO) [Math.9]

It is noted that the working points of Examples 1-3 all fall within the range of 1000 degrees C. to 1050 degrees C. and have excellent workability. On the other hand, Examples 4-11 do not satisfy the above-noted conditions and the working point is lower than 1000 degrees C., which means that the workability is not as good as that of Examples 1-3.

II. Lamp and Glass Part for Lamp

The following now describes a lamp and a glass part for a lamp both according to embodiments of the present embodiment.

### Embodiment 1

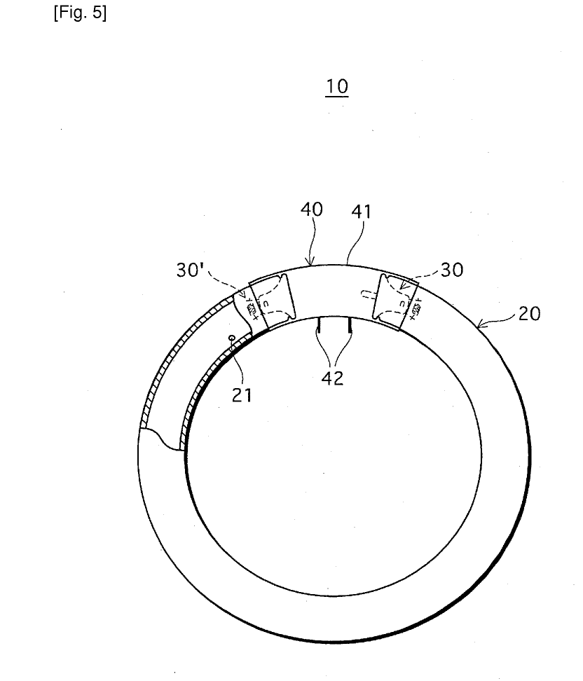

FIG. 5 is a partly-broken plan view of a circular fluorescent lamp according to Embodiment 1 of the present invention. As shown in FIG. 5, a lamp 10 according to Embodiment 1 is a circular fluorescent lamp (FCL30ECW/28) and has a circular glass bulb 20, a pair of stems 30 and 30′ sealed at each end of the glass bulb 20, and a base 40 disposed to straddle the ends of the glass bulb 20.

The glass bulb 20 is one example of a glass part for use in a lamp, according to the present embodiment and is manufactured from the glass composition according to the present invention. The inner surface of the glass bulb 20 is coated with a protective layer (not illustrated) and a phosphor layer (not illustrated) in the stated order. The glass bulb 20 encloses a piece of amalgam 21 and a noble gas such as an argon gas.

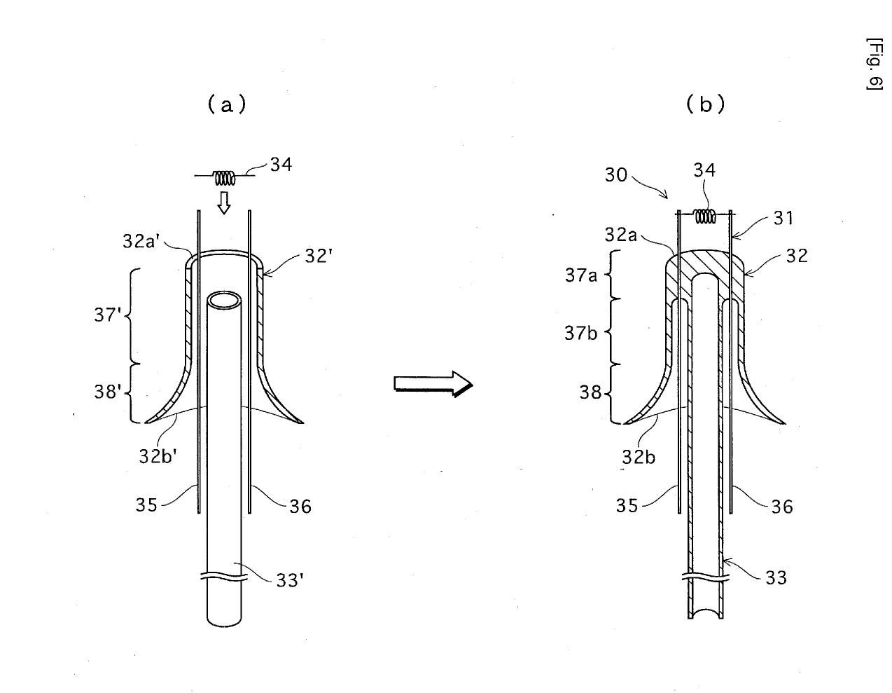

FIG. 6 is a view illustrating a stem before being attached to a glass bulb. In FIG. 6, (a) shows members forming the stem and (b) shows a sectional view of the stem. As shown in (a) of FIG. 6, the stem 30 is assembled from a filament coil 34, a pair of lead wires 35 and 36, a flared tube 32′, and a thin glass tube 33′. As shown in (b) of FIG. 6, the stem 30 in assembled relationship is composed of an electrode 31, a flare 32 to which the electrode 31 is sealingly attached, and an exhaust pipe 33 fused to the flare 32.

The electrode 31 is composed of the filament coil 34 and the pair of lead wires 35 and 36. The filament coil 34 is attached to one end of each of the lead wires 35 and 36 (i.e., one of two ends of each lead wire exposed within the glass bulb 20) by, for example, riveting or welding in a manner to bridge the ends of the respective lead wires 35 and 36.

The flare 32 is one example of a glass part according to the present embodiment and is manufactured from the glass composition according to the present invention. The flare 32 has a mount portion 37a to which the pair of lead wires 35 and 36 are sealed, a tubular portion 37b extending from the mount portion 37a in a direction away from the filament coil 34, and a flange portion 38 extending from the tubular portion 37b further in the direction away from the filament coil 34.

The flare 32 is formed by processing the flared tube 32′. More specifically, a straight portion 37′ of the flared tube 32′ is partly fused with one end of the thin glass tube 33′ to form the mount portion 37a of the flare 32. The remainder of the straight portion 37′ is left without being fused and deformed to form the tubular portion 37b of the flare 32. In addition, a flared portion 38′ of the flared tube 32′ becomes the flange portion 38 of the flare 32 without being processed. The flange portion 38 is partly fusion-welded to one end of the glass bulb 20 in a bulb-sealing process. Note that the glass composition from which the flare 32 is manufactured can be identified by examining the tubular portion 37b which is free from a possibility of being mixed with glass of the glass bulb 20 and the exhaust pipe 33.

The exhaust pipe 33 is one example of a glass part according to the present embodiment and is manufactured from the glass composition according to the present invention. The exhaust pipe 33 is formed by processing the thin glass tube 33′ and used to evacuate gas from the glass bulb 20 to create a vacuum therein and also to place the amalgam piece 21. The end of the thin glass tube 33′ is fused with the mount 37a of the flare 32.

The base 40 has a main body 41 for accommodating the ends of the glass bulb 20 and also has a plurality of connection pins 42 disposed on the main body 41.

The lamp 10 according to Embodiment 1 described above has the glass bulb 20, the flare 32, and the exhaust pipe 33 each manufactured from the glass having good workability, the manufacturing yield of those glass parts improves. In addition, the flare 32 is manufactured from the glass having an expansion coefficient at 30 degrees C. to 380 degrees C. falls within the range of 90 *10⁻⁷K⁻¹ to 100*10⁻⁷K⁻¹, the risk that cracks occur to the stem 30 is low and thus a long lamp life is expected.

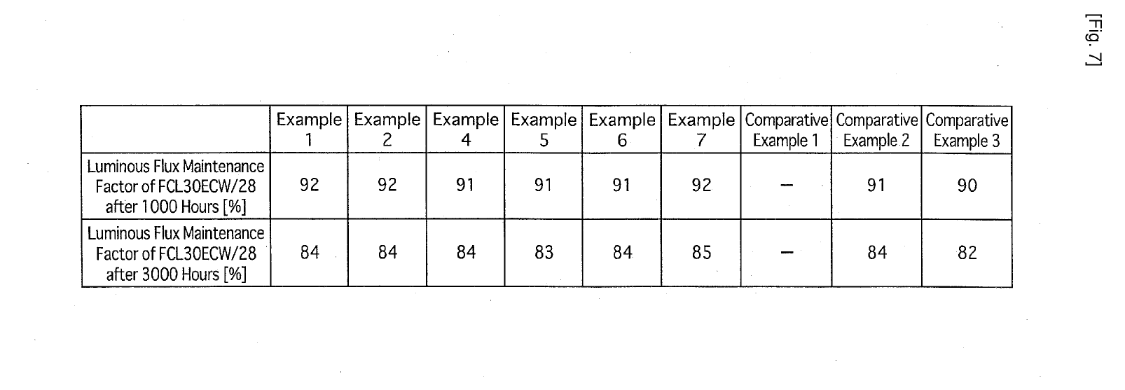

FIG. 7 is a table showing the luminous flux maintenance factors of circular fluorescent lamps. For the evaluation of the luminous flux maintenance factors, a plurality of circular fluorescent lamps identical in structure to the lamp 10 were manufactured from: the glass compositions according to Examples 1, 2, and 4-7 shown in FIG. 1; the glass compositions according to Comparative Examples 1 and 2 shown in FIG. 4; and conventional soft glass used for a circular fluorescent lamp. The conventional soft glass is hereinafter referred to as Comparative Example 3.

For making the evaluation, each circular fluorescent lamp was subjected to a lamp operation test to measure the luminous flux at predetermined time intervals. Based on the measurements, the luminous flux maintenance factors at 1000 hours and 3000 hours of lamp operation were calculated relative to the luminous flux at 100 hours taken as 100%. Note that the glass composition according to Comparative Example 1 undergoes devitrification, so that a clear glass tube cannot be manufactured. Thus, no circular fluorescent lamp was manufactured from the glass composition according to Comparative Example 1 and thus no evaluation of the luminous flux maintenance factor was made on Comparative Example 1.

The evaluation results shown in FIG. 7 makes it clear that the circular fluorescent lamps manufactured from glass of low electric conductivity exhibited relatively higher luminous flux maintenance factors. It is also said that all the circular fluorescent lamps manufactured from glass of Examples according to the present invention exhibited luminous flux maintenance factors higher than that exhibited by the circular fluorescent lamp manufactured from the conventional soft glass (Comparative Example 3).

### Embodiment 2

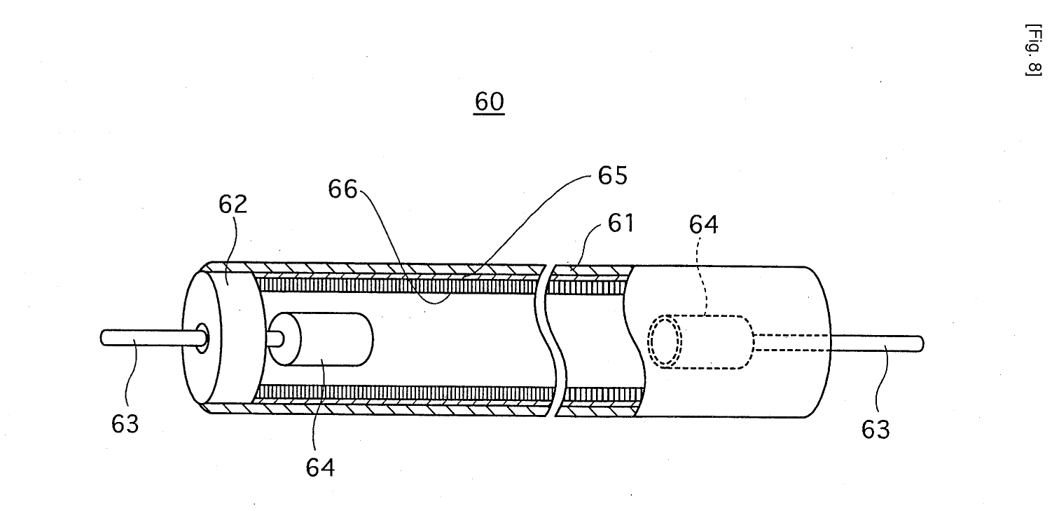

FIG. 8 is a partly-broken plan view schematically showing a cold cathode fluorescent lamp according to Embodiment 2 of the present invention. As shown in FIG. 8, a cold cathode fluorescent lamp 60 according to Embodiment 2 has a glass bulb 61 that is a straight tube having a substantially circular diametrical section.

The glass bulb 61 is an example of a glass part according to the present invention and manufactured from the glass composition according to the present invention. The glass bulb 61 measures 720 mm in length, 4.0 mm in outside diameter, and 3.0 mm in inside diameter.

To each end of the glass bulb 61, a lead wire 63 is sealed via a glass bead 62. The lead wire 63 may be composed of an internal lead wire made of tungsten and an eternal lead wire made of nickel that are connected together. At the tip of each internal lead wire, a cold cathode electrode 64 is fixedly provided.

The glass bead 62 and the glass bulb 61 are attached to each other by, for example, fusing, whereas the glass bead 62 and the lead wire 63 are attached to each other by using, for example, glass frit. As a result, the glass bulb 61 is sealed air-tight. Note that the electrode 64 and the lead wire 63 are attached to each other by, for example, laser welding.

Each electrode 64 is a so-called hollow electrode having the shape of a bottomed tube. By virtue of the hollow electrodes, spattering resulting from discharge during lamp operation is suppressed.

The glass bulb 61 encloses therein mercury at a predetermined ratio to the volume of the glass bulb 61, for example 0.6 mg/cc. In addition, the glass bulb 61 is filled with a rare gas at a predetermined pressure, for example, 60 Torr. The rare gas may be a mixture of argon and neon and the proportions of Ar and Ne is 5% and 95%.

The inner surface of the glass bulb 61 is coated with a protective layer 65, and an exposed surface of the protective layer 65 (the surface that faces away from the inner surface of the glass bulb) is coated with a phosphor layer 66. The protective layer 65 is made from, for example, a metal oxide such as yttrium oxide (Y₂O₃) that serves to suppress reaction of the glass bulb 61 with mercury enclosed in the glass bulb 61. Note that provision of the protective layer 65 is optional and may be omitted in the case where alkaline elution of the glass tube is significantly suppressed.

The phosphor layer 66 converts excitation light from mercury into white light. The phosphor layer 66 contains particles of three difference colors of phosphor, namely red, blue, and green phosphors that covert excitation light into light of the respective colors.

The phosphor particles employed herein are rare earths not containing alumina. Specific examples of such phosphors include Y₂O₃:Eu³⁺ as a red phosphor, LaPO₄:Tb³⁺ as a green phosphor, and (SrCaBa)₁₁(PO4)₆Cl₂:Eu²⁺ as a blue phosphor.

As described above, the cold cathode fluorescent lamp 60 according to Embodiment 2 of the present invention improves the manufacturing yield since the glass bulb 61 having good workability. In addition, the glass from which the glass parts are manufactured has an expansion coefficient that falls within the range of 90*10⁻⁷K⁻¹ to 100*10⁻⁷K⁻¹ at 30 degrees C. to 380 degrees C., the risk that cracks occur to the glass bead 62 is low and thus a long lamp life is expected.

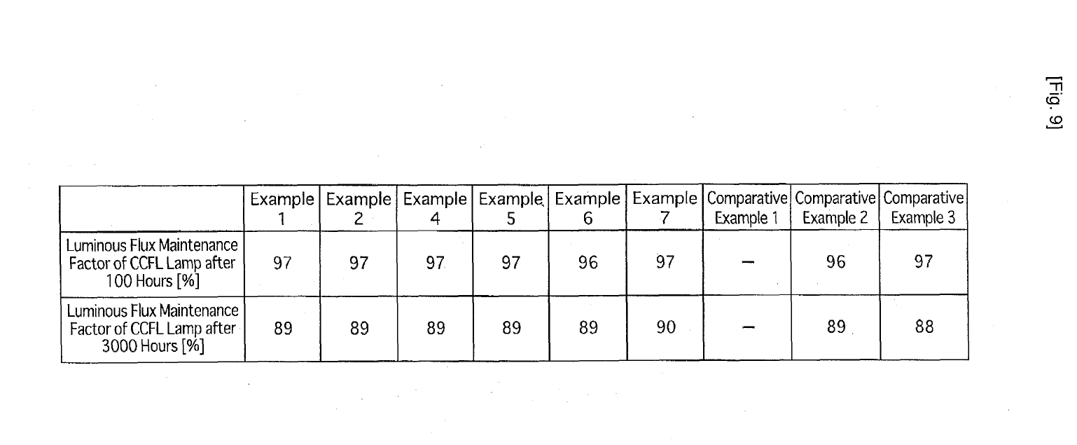

FIG. 9 is a table showing the luminous flux maintenance factors of cold cathode fluorescent lamps. For the evaluation of the luminous flux maintenance factors, a plurality of cold cathode fluorescent lamps identical in structure to the cold cathode fluorescent lamp 60 were manufactured from: the glass compositions according to Examples 1, 2 and 4-7 shown in FIG. 1; the glass compositions according to Comparative Examples 1-2 shown in FIG. 4; and conventional hard glass conventionally used for a cold cathode fluorescent lamp. The conventional hard glass is hereinafter referred to as Comparative Example 4.

For making the evaluation, each cold cathode fluorescent lamp was subjected to a lamp operation test to measure the luminous flux at predetermined time intervals. Based on the measurements, the luminous flux maintenance factors at 100 hours and 3000 hours of lamp operation were calculated relative to the luminous flux at 0 hours taken as 100%. Note that the glass composition according to Comparative Example 1 undergoes devitrification, so that a clear glass tube cannot be manufactured. Thus, no cold cathode lamp was manufactured from the glass composition according to Comparative Example 1 and thus no evaluation of the luminous flux maintenance factor was made on Comparative Example 1.

The evaluation results shown in FIG. 9 makes it clear that the cold cathode fluorescent lamps manufactured from glass of low electric conductivity exhibited relatively higher luminous flux maintenance factors. It is also said that all cold cathode fluorescent lamps manufactured from the glass of Examples according to the present invention exhibited luminous flux maintenance factors comparable to or higher than that exhibited by the cold cathode fluorescent lamp manufactured from the conventional hard glass (Comparative Example 4).

### Modification

Up to this point, the lamp and the glass part for a lamp according to the present invention have been described using the specific embodiments. It should be naturally appreciated, however, that the lamp and the glass part for a lamp are not limited to those disclosed above.

For example, the glass parts for use in a lamp are not limited to glass bulbs, flares, exhaust pipes, and glass beads. Rather, the glass parts according to the present invention include glass parts for use in the manufacturing of a lamp, such as mercury capsules. Note that a mercury capsule is a pre-sealed glass capsule containing liquid mercury and used to dose mercury in a lamp. Such a mercury capsule is disposed inside a lamp and later opened to fill the lamp with mercury.

In addition, the lamps according to the present invention may be any types of fluorescent lamps including circular fluorescent lamps, cold cathode fluorescent lamps, double circular fluorescent lamps, square fluorescent lamps, double square fluorescent lamps, twin fluorescent lamps, and straight fluorescent lamps.

III. Illumination Device

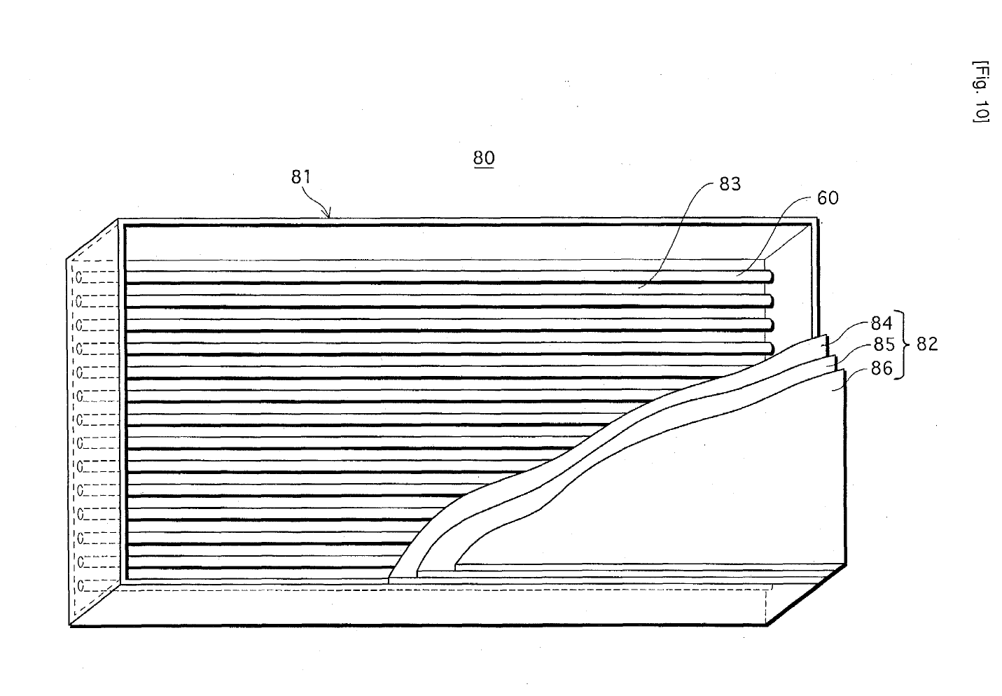

FIG. 10 is an oblique view schematically showing an illumination device according to a modification of the present invention. As shown in FIG. 10, an illumination device 80 according to the modification is a direct-type backlight unit and includes a plurality of cold cathode fluorescent lamps 60, a casing 81 housing the cold cathode fluorescent lamps 60, and a front panel 82 covering the opening of the casing 81.

The casing 81 is made of, for example, a polyethylene terephthalate (PET) resin and has inner surfaces 83 on which metal such as silver is deposited by evaporation to make them reflective surfaces. Naturally, the casing 81 may be made from any material other than a resin, and a metal material such as aluminum is one example.

According to this modification, the illumination device 80 has a total of fourteen cold cathode fluorescent lamps 60 that are in axially parallel relationship with one another along the lengthwise directions of the casing 81. The cold cathode fluorescent lamps 60 are operated by a driving circuit (not illustrated).

The opening of the casing 81 is sealingly covered by the front panel 82 that is translucent to prevent foreign matter, such as dust and dirt, from getting into the casing 81. The front panel 82 is composed of a diffusion plate 84, a diffusion seat 85, and a lens sheet 86 laminated onto one another.

The diffusion plate 84 and the diffusion seat 85 cause scattering and diffusion of light emitted from the cold cathode fluorescent lamps 60. The lens sheet 86 is to collimate the diffused light in the direction of the normal of the lens sheet 86. By virtue of the above structure, light emitted from the cold cathode fluorescent lamps 60 is so adjusted that the entire surface (light-emitting surface) of the front panel 82 uniformly emits light toward the front.

As above, the illumination device according to the present invention has been described with reference to the modification. It is naturally appreciated, however, that the illumination device according to the present invention is not limited to the specific modification disclosed above. For example, the illumination device according to the present invention may be any other types of illumination devices, including indoor and outdoor illumination devices, illumination devices for desktop uses and portable uses, illumination devices for use with display devices, backlight of liquid crystal displays, and illumination devices for image scanning.

### INDUSTRIAL APPLICABILITY

The glass composition for a lamp according to the present invention is applicable to the wide range of illumination purposes.

1. A glass composition for a lamp, comprising the following constituents expressed in terms of oxides:
65 wt % to 75 wt % of SiO₂;
1 wt % to 5 wt % of Al₂O₃;
0.5 wt % to 5 wt % of Li₂O;
5 wt % to 12 wt % of Na₂O;
3 wt % to 7 wt % of K₂O;
12 wt % to 18 wt % of Li₂O+Na₂O+K₂O;
2.1 wt % to 7 wt % of MgO;
2 wt % to 7 wt % of CaO;
0 wt % to 0.9 wt % of SrO;
7.1 wt % to 12 wt % of BaO; and
substantially no PbO.

2. A glass composition for a lamp, comprising the following constituents expressed in terms of oxides:
65 wt % to 75 wt % of SiO₂;
1 wt % to 3 wt % of Al₂O₃;
1 wt % to 3 wt % of Li₂O;
7 wt % to 10 wt % of Na₂O;
3 wt % to 6 wt % of K₂O;
13 wt % to 17 wt % of Li₂O+Na₂O+K₂O;
3 wt % to 6 wt % of MgO;
3 wt % to 6 wt % of CaO;
0 wt % to 0.9 wt % of SrO;
7.1 wt % to 10 wt % of BaO; and
substantially no PbO.

3. The glass composition according to claim 1, wherein a content ratio by weight defined by the following relationship is satisfied.
0.76≦(MgO+CaO)/(SrO+BaO)≦1.19 [Math.1]

4. The glass composition according to claim 1, wherein
the total content of Li₂O+Na₂O+K₂O is less than 15.8 wt %,
the total content of MgO, CaO, SrO, and BaO is less than 15.6 wt %, and
a content ratio by weight defined by the following relationship is satisfied.
0.76 [symbol] (MgO+CaO)/(SrO+BaO) [Math.2]

5. The glass composition according to claim 1, wherein
a softening point falls within a range of 650 degrees C. to 720 degrees C.

6. The glass composition according to claim 1, wherein
a thermal expansion coefficient at a temperature from 30 degrees C. to 380 degrees C. falls within a range of 90*10⁻⁷K⁻¹ to 100*10⁻⁷K⁻¹.

7. A glass part for a lamp, wherein
the glass part is manufactured from the glass composition defined in claim 1.

8. A lamp comprising:
the glass part defined in claim 7.

9. An illumination device comprising:
the lamp defined in claim 8.
